(19) United States
(12) Patent Application Publication
(10) Pub. No.: US 2026/0065449 A1
(43) Pub. Date: Mar. 5, 2026

(54) APPLYING EFFECTS TO HDR VIDEO

(71) Applicant: Lemon Inc., Grand Cayman (KY)

(72) Inventor: Chaoyi Tan, Los Angeles, CA (US)

(21) Appl. No.: 18/821,455

(22) Filed: Aug. 30, 2024

(51) Int. Cl. G06T 5/92; G06V 10/56; G06V 10/60

(52) U.S. Cl. CPC G06T 5/92; G06V 10/56; G06V 10/60; G06T 2207/20208

(57) ABSTRACT

A computing system is provided for applying effects to a High Dynamic Range (HDR) video by receiving a video frame of the HDR video, the video frame comprising a plurality of pixels, each pixel having one or more brightness values for each color component, and applying an electro-optical transfer function, a tone mapping algorithm, and an opto-electric transfer function to each pixel in the video frame of the HDR video, in this order. Subsequently, a video frame of a Standard Dynamic Range (SDR) video is generated with transformed brightness values for each color component, then one or more effects are applied to the video frame of the SDR video to thereby generate an edited SDR video, and an output is generated based on the edited SDR video.

### BACKGROUND

Video technologies have evolved to significantly advance visual quality, particularly with the advent of High Dynamic Range (HDR) video. HDR video provides a greater range of luminosity and color depth compared to Standard Dynamic Range (SDR) video. For example, HDR is characterized by brighter whites, darker blacks, and a wider potential number of visible colors, which result in more vivid and true-to-life images. This increased color depth and expanded dynamic range make HDR superior in delivering more immersive visual experiences, particularly when compared to SDR video, which operates within a more limited color gamut and narrower range of brightness levels.

With the growing adoption of HDR-enabled cameras and displays, especially in mobile devices, modern smartphones, tablets, and cameras now commonly support HDR video recording and playback, bringing a professional-grade viewing experience to the consumer market.

However, the proliferation of HDR video content has also presented challenges when attempting to apply effects designed for SDR video. Applications (apps) and software that were originally developed for SDR video are often not optimized to handle the increased color depth and dynamic range of HDR content. When such apps are used on HDR video, the mismatch between the two formats can lead to severe color distortions. These distortions can manifest as oversaturation or desaturation in certain color spaces, resulting in an unnatural or undesirable appearance of the video.

### SUMMARY

In view of the above, a computing system is provided for applying effects to a High Dynamic Range (HDR) video. The computing system comprises processing circuitry and memory storing instructions that, when executed, cause the processing circuitry to receive a video frame of the HDR video, the video frame comprising a plurality of pixels, each pixel having one or a plurality of brightness values for each of a plurality of color components, and apply an HDR-to-SDR pipeline, including an electro-optical transfer function, a tone mapping algorithm, and an opto-electric transfer function to each pixel in the video frame of the HDR video, in this order. Subsequently, a video frame of a Standard Dynamic Range (SDR) video is generated with transformed brightness values for each of the plurality of color components, then one or more effects are applied to the video frame of the SDR video to thereby generate an edited SDR video, and an output is generated based on the edited SDR video.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates an example of the effects that may be applied to a video by the effects module in the computing system of FIG. 1.

FIG. 3 illustrates a detailed schematic view of the operations of the tone mapping algorithm in the computing system of FIG. 1.

FIG. 4 is a flow chart of a method for applying effects to a HDR video according to an example embodiment of the present disclosure.

FIG. 5 is a flow chart of a method for tone mapping according to an example embodiment of the present disclosure.

FIG. 6 shows an example computing environment of the present disclosure.

### DETAILED DESCRIPTION

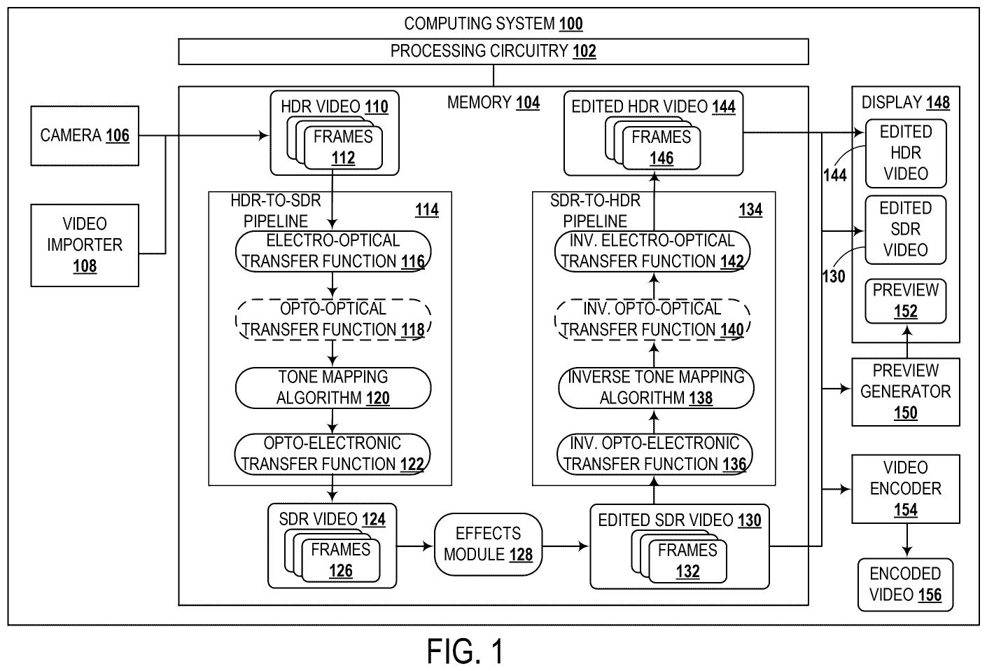

FIG. 1 shows a schematic view of an example computing system 100 for applying effects to a High Dynamic Range (HDR) video 110. The example computing system 100 can be implemented with various types of computing devices, including mobile devices, smart phones, personal computers, laptops, computing servers, etc. The example computing system 100 includes processing circuitry 102 and memory 104 storing instructions that, during execution, causes the processing circuitry 102 to perform the various processes described herein to generate video frames 132 of an edited Standard Dynamic Range (SDR) video 130 and/or video frames 146 of an edited HDR video 144 with effects added, which may be outputted for rendering on a display 148 and/or encoded by a video encoder 154 to generate and output an encoded video 156. The display 148 may be a display device within the computing system 100 or an external device that is communicatively coupled to the computing system 100.

The computing system 100 further includes a camera 106 configured to capture HDR video 110, which is subsequently transferred into the memory 104 for further processing by an HDR-to SDR pipeline 114. The video data of the HDR video 110 may be initially processed by an image signal processor before being transferred to the memory 104. Alternatively, the video data of the HDR video 110 may be transferred directly into the memory 104 in real-time via a high-speed communication interface, such as Universal Serial Bus (USB), Thunderbolt, or high-definition multimedia interface (HDMI). The high-speed communication interface may implement wireless technology via Wi-Fi transmission, Bluetooth, wireless HDMI, or cellular networks, for example.

Alternatively, the HDR video 110 may be imported from various external sources by a video importer 108 and subsequently transferred into the memory 104. For example, the video importer 108 may be embodied as a capture hardware configured to capture HDR video 110 from external cameras and transfer the video data into the memory 104.

The HDR-to-SDR pipeline 114 processes the video frames 112 of the HDR video 110 to generate video frames 126 of a SDR video 124. Each video frame 112 comprises a plurality of pixels, each pixel having one or a plurality of brightness values for each color component. For example, the inputted HDR video 110 may have a wide-gamut Rec. 2020 color space with a color depth of 10 bits. The outputted SDR video 124 may have a narrow-gamut Rec. 709 color space with a color depth of 8 bits. Each pixel of each video frame 112 is processed by the plurality of functions 116, 118, 120, 122 of the HDR-to-SDR pipeline 114 to generate the video frame 126 of the SDR video 124.

In this example, an electro-optical transfer function 116, an opto-optical transfer function 118, a tone mapping algorithm 120, and an opto-electric transfer function 122 are applied to each pixel in the video frame 112 of the HDR video 110, in this order, thereby generating a video frame 126 of the SDR video 124 with transformed brightness values for each of the plurality of color components. In some embodiments, the opto-optical transfer function 118 may be omitted, so that only the electro-optical transfer function 116, the tone mapping algorithm 120, and the opto-electric transfer function 122 are applied to each pixel in the video frame 112 of the HDR video 110. The functions 116, 118, 120, 122 of the HDR-to-SDR pipeline 114 may be applied to each pixel in the video frame 112 in real-time as the video frame 112 is received from the camera 106, such that the video frame 126 of the generated SDR video 124 is outputted for rendering on the display 148 without perceptible delay.

The electro-optical transfer function 116 specifies the manner in which brightness levels encoded in each pixel of the video frame 112 of the HDR video 110 are mapped to actual light intensities on the target display 148. For example, the Hybrid Log-Gamma (HLG) transfer function or Perceptual Quantizer (PQ) may be selected as the electro-optical transfer function 116. The opto-optical transfer function 118 specifies the mathematical relationship between the real-world luminance, or scene-referred light, and the display-referred light, or the luminance that is rendered on the display 148.

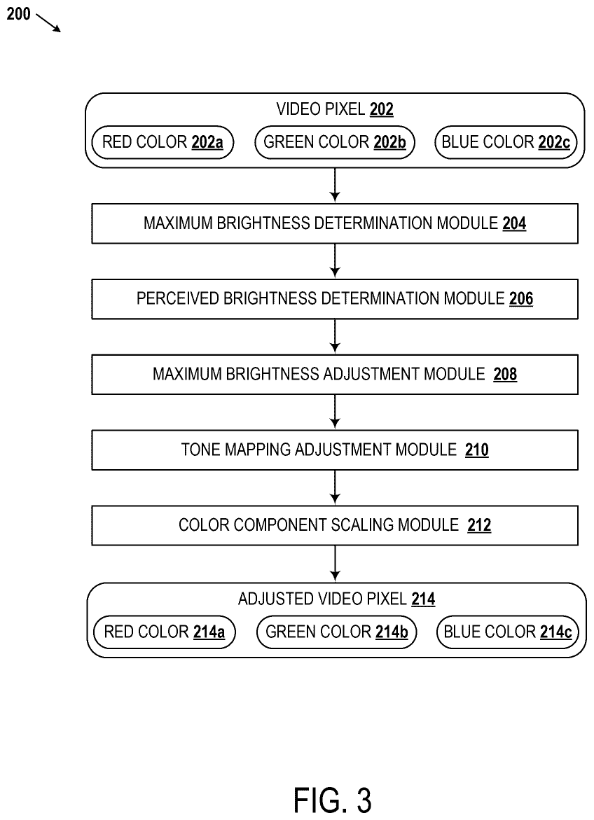

The tone mapping algorithm 120 compresses the range of brightness values in the video frames 112 of the HDR video 110 to fit within the limits of the display 148 while preserving the visual details and contrast of the original HDR video 110 to the furthest extent possible within the physical limitations of the display 148. An example of the operations of the tone mapping algorithm 120 is described in further detail with reference to FIG. 3.

The opto-electronic transfer function 122 further applies a non-linear curve to compress the brightness values of each pixel in each video frame 112 while preserving details in shadows. Accordingly, visual details may be preserved in both the brightest highlights and the deepest shadows of each video frame 112.

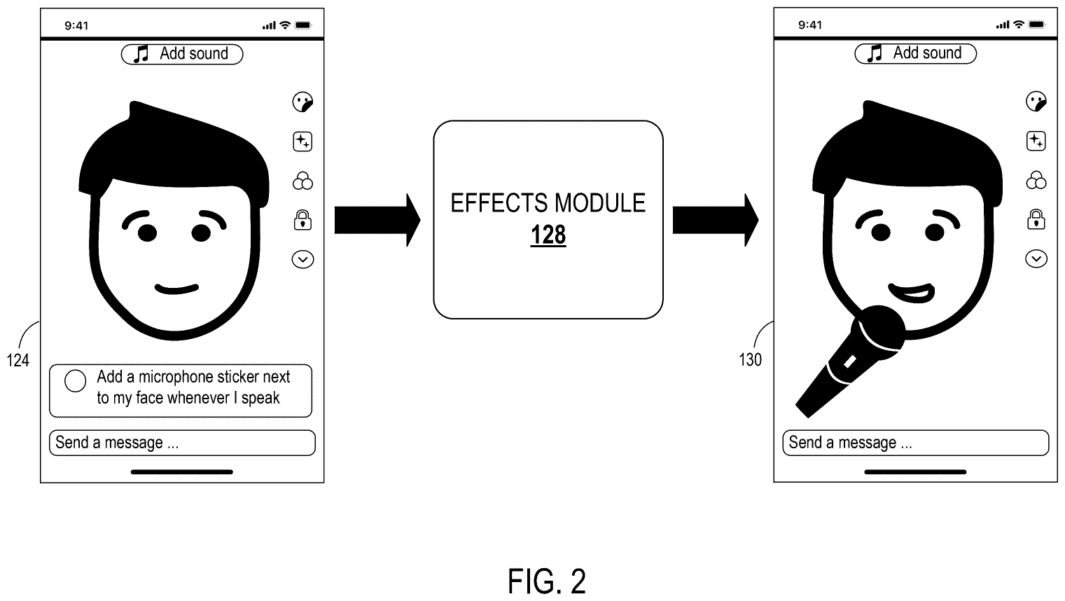

Subsequent to each pixel in each video frame 112 of the HDR video 110 being processed by the HDR-to-SDR pipeline 114, video frames 126 of a SDR video 124 are generated for input into an effects module 128, which is configured to apply effects to at least some of the video frames 126 of the SDR video 124, reassemble the modified video frames into an edited SDR video 130, and generate the edited SDR video 130 with at least some of the video frames 132 including the effects applied by the effects module 128. These effects may range from relatively simple effects, such as color grading, cropping, and trimming, to more complex effects such as filters, stickers, text, motion tracking, audio modifications, or transitions, for example. One example of a visual effect that may be applied to the video frames 126 of the SDR video 124 is described with reference to FIG. 2.

An output is subsequently generated based on the edited SDR video 130. For example, the edited SDR video 130 may be outputted for rendering on the display 148, encoded by the video encoder 154 to generate and output an encoded video 156 formatted for storage or sharing, and/or further processed in an SDR-to-HDR pipeline 134 to generate an edited HDR video 144. The SDR-to-HDR pipeline 134 comprises inverse versions of the functions 116, 118, 120, 122 of the HDR-to-SDR pipeline 114. In this example, an inverse opto-electric transfer function 136, an inverse tone mapping algorithm 138, an inverse opto-optical transfer function 140, and an inverse electro-optical transfer function 142 of the SDR-to-HDR pipeline 134 are inverses of the opto-electronic transfer function 122, the tone mapping algorithm 120, the opto-optical transfer function 118, and the electro-optical transfer function 116 of the HDR-to-SDR pipeline 114, respectively. Therefore, when the opto-optical transfer function 118 is omitted from the HDR-to-SDR pipeline 114, the inverse opto-optical transfer function 140 is likewise omitted from the SDR-to-HDR pipeline 134.

The inverse functions 136, 138, 140, 142 of the SDR-to-HDR pipeline 134 are applied to each pixel in a video frame 146 of the edited SDR video 144 to generate a video frame 146 of the edited HDR video 144 including the added effects applied by the effects module 128. The edited HDR video 144 may be outputted for rendering on the display 148 and/or encoded by the video encoder 154 to generate and output an encoded video 156 formatted for storage or sharing.

The computing system 100 may further execute a preview generator 150 configured to generate a preview 152 for rendering on the display 148 based on the edited HDR video 144 and/or the edited SDR video 130 before a user authorizes the video encoder 154 to generate an encoded video 156 for sharing. For example, a preview 152 may be rendered on the display 148 based on the edited SDR video 130, a user input may be received to generate an edited HDR video 144, and responsive to receiving the user input to generate the edited HDR video 144, the SDR-to-HDR pipeline 134 may be applied to generate a video frame 146 of an edited HDR video 144.

Referring to FIG. 2, an example of a visual effect that may be applied by the effects module 128 to the video frames of the SDR video 124 is described. In this example, the visual effect that is applied to the SDR video 124 is a motion tracking effect which applies a microphone sticker next to the face of the user every time the user speaks. The user commands the chat application to “add a microphone speaker next to my face whenever I speak”. In response, the chat application causes the effects module 128 to apply the microphone sticker next to the face of the user in the original HDR video.

Referring to FIG. 3, an example of the operations 200 of the tone mapping algorithm 120 in the computing system 100 of FIG. 1 is described in further detail. In this depiction, the operations 200 transform a given pixel 202 in the video frame 112 of the original HDR video 110 of FIGS. 1 and 2. The given pixel 202 has three color components that are transformed by the tone mapping algorithm 120: the red color component 202a, the green color component 202b, and the blue color component 202c. The given pixel 202 is initially processed by the maximum brightness determination module 204 to determine a maximum brightness value among the color components 202a, 202b, 202c of the given pixel 202. The perceived brightness determination module 206 determines a perceived brightness value of the given pixel 202 using weights for the Rec. 709 standard for high-definition TV (HDTV) or weights for the Rec. 2020 standard for ultra-high-definition TV (UHDTV). The maximum brightness adjustment module 208 adjusts the maximum brightness value of the given pixel 202 based on the perceived brightness value.

The tone mapping adjustment module 210 determines an adjustment factor of the given pixel 202 based on the adjusted maximum brightness value and a peak luminance of the display 148. The adjustment factor may be determined by using a tone mapping function. Examples of tone mapping functions that can be used to determine the adjustment factor include a linear function, a logarithmic function, an exponential function, Reinhard's formula, and filmic tone mapping operators, such as the Hable Tone Mapping Operator or the Academy Color Encoding System (ACES). Filmic tone mapping operators are configured to compress the luminance values of each pixel while maintaining a “cinematic” or “filmic” aesthetic which mimics how traditional film processes light and color. The color component scaling module 212 scales each color component 202a, 202b, 202c of the given pixel 202 based on the adjustment factor to generate an adjusted pixel 214 with a scaled red color component 214a, a scaled green color component 214b, and a scaled blue color component 214c. The adjusted pixel 214 may be further processed by applying an opto-electronic transfer function in subsequent downstream processing modules, for example.

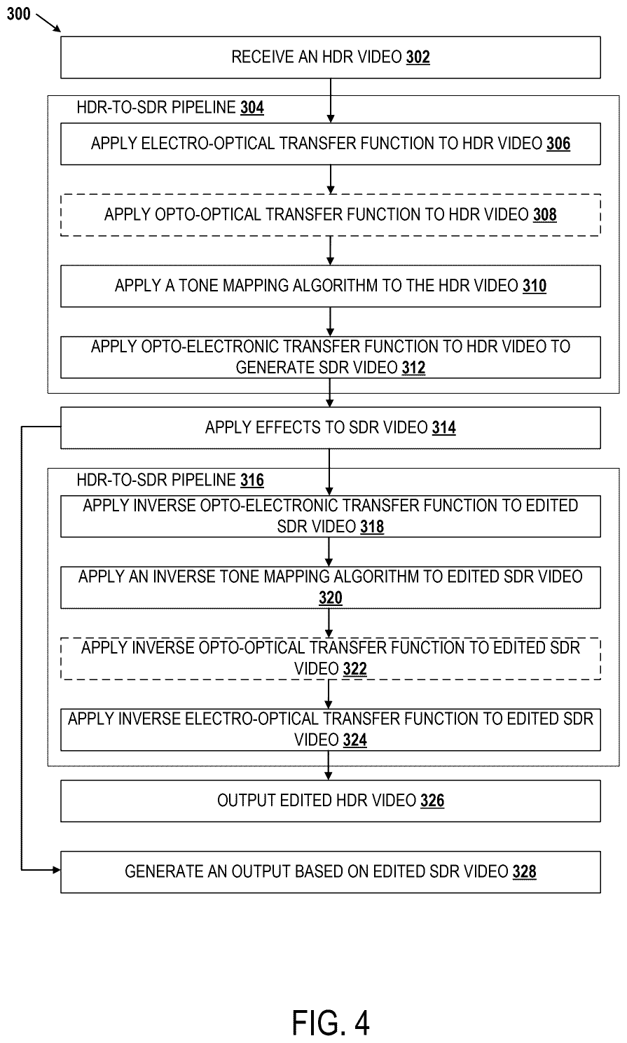

FIG. 4 shows a process flow diagram of an example method 300 for applying effects to HDR videos. The example method 300 includes, at step 302, receiving an HDR video. The HDR video can be received in various ways and from various sources, including from a camera configured to capture HDR video or a video importer configured to import the HDR video from various external sources, for example. The example method 300 includes, at step 304, processing the received HDR video with the HDR-to-SDR pipeline to generate a SDR video based on the received HDR video.

Step 304 includes step 306 of applying an electro-optical transfer function to the HDR video. The HLG transfer function or PQ may be selected as the electro-optical transfer function, for example.

Step 304 optionally includes, at step 308, applying an opto-optical transfer function to the HDR video. The opto-optical transfer function specifies the mathematical relationship between the real-world luminance, or scene-referred light, and the display-referred light, or the luminance that is rendered on the display.

Step 304 includes, at step 310, applying a tone mapping algorithm to the HDR video. The tone mapping algorithm compresses the range of brightness values in the video frames of the SDR video to fit within the limits of the display while preserving the visual details and contrast of the original HDR video to the furthest extent possible within the physical limitations of the display.

Step 304 includes, at step 312, applying an opto-electronic transfer function to the HDR video to generate a SDR video. The opto-electronic transfer function further applies a non-linear curve to compress the brightness values of each pixel in each video frame while preserving details in shadows.

The example method 300 includes, at step 314, applying effects to the SDR video. Step 314 includes applying effects to at least some of the video frames of the SDR video, reassembling the video frames into an edited SDR video, and generating the edited SDR video with at least some of the video frames including the applied effects.

Subsequent to applying effects to the SDR video at step 312, at step 328, the example method 300 may include generating an output based on the edited SDR video. The edited SDR video may be outputted for rendering on the display and/or encoded by the video encoder to generate and output an encoded video formatted for storage or sharing.

Alternatively, subsequent to applying effects to the SDR video at step 314, the example method 300 may include step 316 of processing the edited SDR video with an SDR-to-HDR pipeline to generate an edited HDR video based on the edited SDR video. Step 316 includes, at step 318, applying an inverse opto-electronic transfer function to the edited SDR video. The inverse opto-electronic transfer function is the inverse of the opto-electronic transfer function of step 312.

Step 316 further includes, at step 320, applying an inverse tone mapping algorithm to the edited SDR video. The inverse tone mapping algorithm is the inverse of the tone mapping algorithm of step 310. Step 316 includes, at step 324, applying an inverse electro-optical transfer function to the edited SDR video. The inverse electro-optical transfer function is the inverse of the electro-optical transfer function of step 306. Between steps 320 and 324, step 316 may include, at step 322, applying an inverse opto-optical transfer function to the edited SDR video. The inverse opto-optical transfer function is the inverse of the opto-optical transfer function of step 308.

Subsequent to undergoing processing by the SDR-to-HDR pipeline at step 316, the example method 300 may include step 326 of outputting the edited HDR video. The edited HDR video may be outputted for rendering on the display and/or encoded by the video encoder to generate and output an encoded video formatted for storage or sharing.

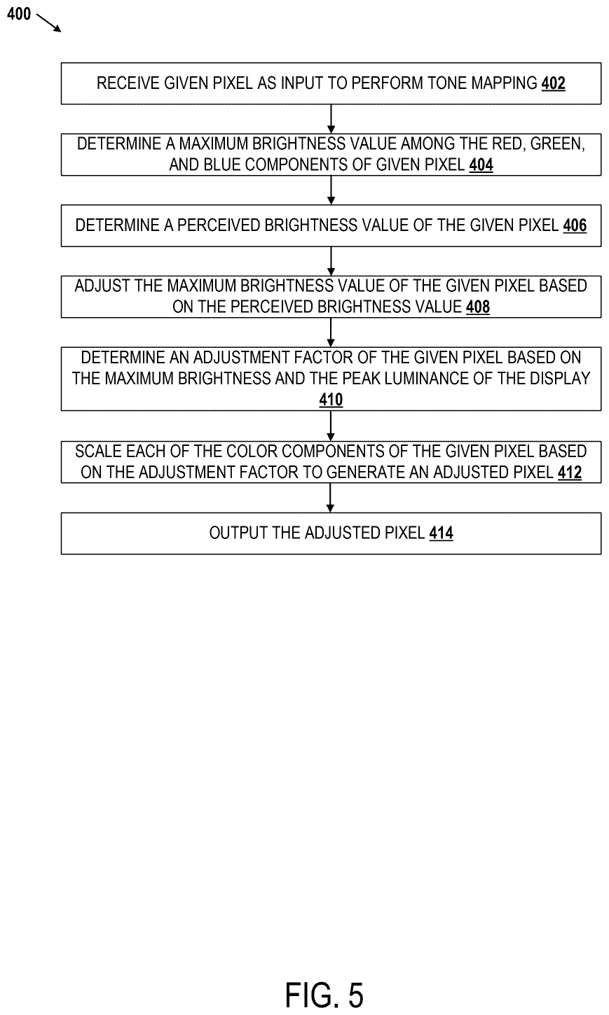

FIG. 5 shows a process flow diagram of an example method 400 for applying a tone mapping algorithm to a video frame of a received HDR video. The example method 400 includes step 402 of receiving a given pixel as input to perform tone mapping. The given in the video frame of the original HDR video has three color components that are transformed by a tone mapping algorithm: the red color component, the green color component, and the blue color component.

The example method 400 further includes step 404 of determining a maximum brightness value among the red, green, and blue components of the given pixel. The example method 400 further includes step 406 of determining a perceived brightness value of the given pixel. Weights for the Rec. 709 standard for HDTV or weights for the Rec. 2020 standard for UHDTV may be used to determine the perceived brightness value of the given pixel.

The example method 400 further includes step 408 of adjusting the maximum brightness value of the given pixel based on the perceived brightness. The example method 400 further includes step 410 of determining an adjustment factor for the given pixel based on the adjusted maximum brightness value and a peak luminance of the display. The adjustment factor can be determined by using a tone mapping function. Examples of tone mapping functions that can be applied include a linear function, a logarithmic function, an exponential function, Reinhard's formula, and filmic tone mapping operators.

The example method 400 further includes step 412 of scaling each color component of the given pixel based on the adjustment factor to generate an adjusted pixel with a scaled red color component, a scaled green color component, and a scaled blue color component. The example method 400 further includes step 414 of outputting the adjusted pixel, which may be further processed by applying an opto-electronic transfer function in downstream processing steps, for example.

As described throughout herein, by converting HDR video into SDR and then applying effects, users can retain the high-quality effects originally designed for SDR content while ensuring compatibility with the broader color and dynamic range associated with HDR video. This approach allows apps and software, which were initially developed for SDR video processing, to be used effectively on HDR content without introducing visual artifacts or distortions, such as oversaturation or desaturation in certain color spaces. Consequently, this system enhances the viewing experience of published HDR videos with added effects, maintaining the integrity of the visual quality of the original HDR videos. Furthermore, the quality of videos created with HDR-enabled cameras can be increased to meet high standards of visual fidelity and consistency across a range of devices and platforms.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

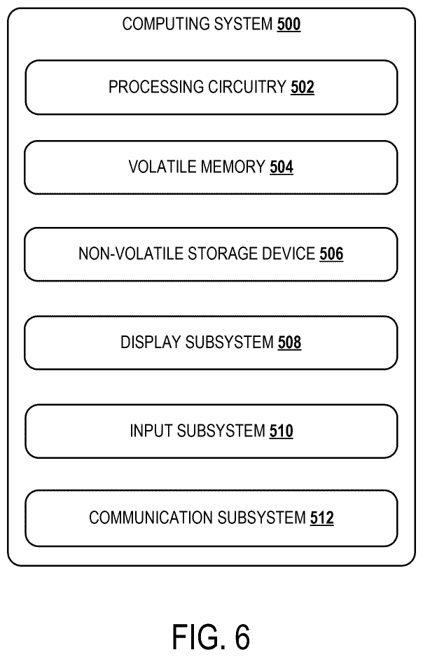

FIG. 6 schematically shows a non-limiting embodiment of a computing system 500 that can enact one or more of the methods and processes described above. Computing system 500 is shown in simplified form. Computing system 500 may embody the computing system 100 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 6.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local-or wide-area network, broadband cellular network, etc. In some embodiments, the communication subsystem may allow computing system 500 to send and/or receive messages to and/or from other devices via a network such as the Internet.

The following paragraphs provide additional description of the subject matter of the present disclosure. One aspect provides a computing system for applying effects to a High Dynamic Range (HDR) video, the computing system comprising processing circuitry and memory storing instructions that, when executed, cause the processing circuitry to receive a video frame of the HDR video, the video frame comprising a plurality of pixels, each pixel having one or a plurality of brightness values for each of a plurality of color components; apply an HDR-to-SDR pipeline, including an electro-optical transfer function, a tone mapping algorithm, and an opto-electric transfer function to each pixel in the video frame of the HDR video, in this order, thereby generating a video frame of a Standard Dynamic Range (SDR) video with transformed brightness values for each of the plurality of color components; apply one or more effects to the video frame of the SDR video to thereby generate an edited SDR video; and generate an output based on the edited SDR video. In this aspect, additionally or alternatively, in the HDR-to-SDR pipeline, an opto-optical transfer function may be further applied to each pixel in the video frame of the HDR video, so that the electro-optical transfer function, the opto-optical transfer function, the tone mapping algorithm, and the opto-electric transfer function are applied to each pixel in the video frame, in this order. In this aspect, additionally or alternatively, the tone mapping algorithm may be executed to determine a maximum brightness value among the color components of a given pixel; determine a perceived brightness value of the given pixel; and adjust the maximum brightness value of the given pixel based on the perceived brightness value. In this aspect, additionally or alternatively, the perceived brightness value of the given pixel may be determined by using weights for the Rec. 709 standard or weights for the Rec. 2020 standard for the color components of the given pixel. In this aspect, additionally or alternatively, the tone mapping algorithm may be further executed to determine an adjustment factor of a given pixel based on the adjusted maximum brightness value and a peak luminance of a display; and scale each color component of the given pixel based on the adjustment factor. In this aspect, additionally or alternatively, the adjustment factor may be determined using a tone mapping function selected from the group consisting of a linear function, a logarithmic function, an exponential function, Reinhard's formula, and a filmic tone mapping operator. In this aspect, additionally or alternatively, the processing circuitry may be further configured to apply an SDR-to-HDR pipeline, including an inverse opto-electric transfer function, an inverse tone mapping algorithm, and an inverse electro-optical transfer function to each pixel in a video frame of the edited SDR video, thereby generating a video frame of an edited HDR video; and output the video frame of the edited HDR video for rendering on a display. In this aspect, additionally or alternatively, the system may further comprise a camera, the electro-optical transfer function, the tone mapping algorithm, and the opto-electric transfer function being applied to each pixel in the video frame in real-time as the video frame is received from the camera, such that the video frame of the SDR video is outputted for rendering on the display without perceptible delay. In this aspect, additionally or alternatively, the electro-optical transfer function may be Hybrid Log-Gamma (HLG). In this aspect, additionally or alternatively, the video frame of the edited SDR video may be inputted into a preview generator to generate a preview for rendering on the display.

Another aspect provides a computing method for applying effects to a High Dynamic Range (HDR) video, the computing method comprising receiving a video frame of the HDR video, the video frame comprising a plurality of pixels, each pixel having one or a plurality of brightness values for each of a plurality of color components; applying an HDR-to-SDR pipeline, including an electro-optical transfer function, a tone mapping algorithm, and an opto-electric transfer function to each pixel in the video frame of the HDR video, in this order, thereby generating a video frame of a Standard Dynamic Range (SDR) video with transformed brightness values for each of the plurality of color components; applying one or more effects to the video frame of the SDR video to thereby generate an edited SDR video; and generate an output based on the edited SDR video. In this aspect, additionally or alternatively, in the HDR-to-SDR pipeline, an opto-optical transfer function may be further applied to each pixel in the video frame of the HDR video, so that the electro-optical transfer function, the opto-optical transfer function, the tone mapping algorithm, and the opto-electric transfer function are applied to each pixel in the video frame, in this order. In this aspect, additionally or alternatively, the tone mapping algorithm may be executed to determine a maximum brightness value among the color components of a given pixel; determine a perceived brightness value of the given pixel; and adjust the maximum brightness value of the given pixel based on the perceived brightness value. In this aspect, additionally or alternatively, the perceived brightness value of the given pixel may be determined by using weights for the Rec. 709 standard or weights for the Rec. 2020 standard for the color components of the given pixel. In this aspect, additionally or alternatively, the tone mapping algorithm may be further executed to determine an adjustment factor of a given pixel based on the adjusted maximum brightness value and a peak luminance of a display; and scale each color component of the given pixel based on the adjustment factor. In this aspect, additionally or alternatively, the adjustment factor may be determined using a tone mapping function selected from the group consisting of a linear function, a logarithmic function, an exponential function, Reinhard's formula, and a filmic tone mapping operator. In this aspect, additionally or alternatively, the method may further comprise applying an SDR-to-HDR pipeline, including an inverse opto-electric transfer function, an inverse tone mapping algorithm, and an inverse electro-optical transfer function to each pixel in a video frame of the edited SDR video, thereby generating a video frame of an edited HDR video; and outputting the video frame of the edited HDR video for rendering on a display. In this aspect, additionally or alternatively, the electro-optical transfer function may be Hybrid Log-Gamma (HLG).

Another aspect provides a computing system for applying effects to a High Dynamic Range (HDR) video, the computing system comprising processing circuitry and memory storing instructions that, when executed, cause the processing circuitry to receive a video frame of the HDR video, the video frame comprising a plurality of pixels, each pixel having one or a plurality of brightness values for each of a plurality of color components; apply an HDR-to-SDR pipeline, including an electro-optical transfer function, a tone mapping algorithm, and an opto-electric transfer function to each pixel in the video frame of the HDR video, in this order, thereby generating a video frame of a Standard Dynamic Range (SDR) video with transformed brightness values for each of the plurality of color components; apply one or more effects to the video frame of the SDR video to thereby generate an edited SDR video; generate a preview for rendering on a display based on the edited SDR video; receive a user input to generate an edited HDR video; responsive to receiving the user input to generate the edited HDR video, apply an SDR-to-HDR pipeline, including an inverse opto-electric transfer function, an inverse tone mapping algorithm, and an inverse electro-optical transfer function to each pixel in a video frame of the edited SDR video, thereby generating a video frame of an edited HDR video; and output the video frame of the edited HDR video for rendering on the display. In this aspect, additionally or alternatively, the system may further comprise a camera, the electro-optical transfer function, the tone mapping algorithm, and the opto-electric transfer function being applied to each pixel in the video frame in real-time as the video frame is received from the camera, such that the video frame of the HDR video is outputted for rendering on the display without perceptible delay.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for applying effects to a High Dynamic Range (HDR) video, the computing system comprising:
processing circuitry and memory storing instructions that, when executed, cause the processing circuitry to:
receive a video frame of the HDR video, the video frame comprising a plurality of pixels, each pixel having one or a plurality of brightness values for each of a plurality of color components;
apply an HDR-to-SDR pipeline, including an electro-optical transfer function, a tone mapping algorithm, and an opto-electric transfer function to each pixel in the video frame of the HDR video, in this order, thereby generating a video frame of a Standard Dynamic Range (SDR) video with transformed brightness values for each of the plurality of color components;
apply one or more effects to the video frame of the SDR video to thereby generate an edited SDR video; and
generate an output based on the edited SDR video.

2. The computing system of claim 1, wherein, in the HDR-to-SDR pipeline, an opto-optical transfer function is further applied to each pixel in the video frame of the HDR video, so that the electro-optical transfer function, the opto-optical transfer function, the tone mapping algorithm, and the opto-electric transfer function are applied to each pixel in the video frame, in this order.

3. The computing system of claim 1, wherein the tone mapping algorithm is executed to:
determine a maximum brightness value among the color components of a given pixel;
determine a perceived brightness value of the given pixel; and
adjust the maximum brightness value of the given pixel based on the perceived brightness value.

4. The computing system of claim 3, wherein the perceived brightness value of the given pixel is determined by using weights for the Rec. 709 standard or weights for the Rec. 2020 standard for the color components of the given pixel.

5. The computing system of claim 1, wherein the tone mapping algorithm is further executed to:
determine an adjustment factor of a given pixel based on the adjusted maximum brightness value and a peak luminance of a display; and
scale each color component of the given pixel based on the adjustment factor.

6. The computing system of claim 5, wherein the adjustment factor is determined using a tone mapping function selected from the group consisting of: a linear function, a logarithmic function, an exponential function, Reinhard's formula, and a filmic tone mapping operator.

7. The computing system of claim 1, wherein the processing circuitry is further configured to:
apply an SDR-to-HDR pipeline, including an inverse opto-electric transfer function, an inverse tone mapping algorithm, and an inverse electro-optical transfer function to each pixel in a video frame of the edited SDR video, thereby generating a video frame of an edited HDR video; and
output the video frame of the edited HDR video for rendering on a display.

8. The computing system of claim 7, further comprising a camera, wherein
the electro-optical transfer function, the tone mapping algorithm, and the opto-electric transfer function are applied to each pixel in the video frame in real-time as the video frame is received from the camera, such that the video frame of the SDR video is outputted for rendering on the display without perceptible delay.

9. The computing system of claim 1, wherein the electro-optical transfer function is Hybrid Log-Gamma (HLG).

10. The computing system of claim 1, wherein the video frame of the edited SDR video is inputted into a preview generator to generate a preview for rendering on the display.

11. A computing method for applying effects to a High Dynamic Range (HDR) video, the computing method comprising:
receiving a video frame of the HDR video, the video frame comprising a plurality of pixels, each pixel having one or a plurality of brightness values for each of a plurality of color components;
applying an HDR-to-SDR pipeline, including an electro-optical transfer function, a tone mapping algorithm, and an opto-electric transfer function to each pixel in the video frame of the HDR video, in this order, thereby generating a video frame of a Standard Dynamic Range (SDR) video with transformed brightness values for each of the plurality of color components;
applying one or more effects to the video frame of the SDR video to thereby generate an edited SDR video; and
generate an output based on the edited SDR video.

12. The computing method of claim 11, wherein in the HDR-to-SDR pipeline, an opto-optical transfer function is further applied to each pixel in the video frame of the HDR video, so that the electro-optical transfer function, the opto-optical transfer function, the tone mapping algorithm, and the opto-electric transfer function are applied to each pixel in the video frame, in this order.

13. The computing method of claim 11, wherein the tone mapping algorithm is executed to:
determine a maximum brightness value among the color components of a given pixel;
determine a perceived brightness value of the given pixel; and
adjust the maximum brightness value of the given pixel based on the perceived brightness value.

14. The computing method of claim 13, wherein the perceived brightness value of the given pixel is determined by using weights for the Rec. 709 standard or weights for the Rec. 2020 standard for the color components of the given pixel.

15. The computing method of claim 11, wherein the tone mapping algorithm is further executed to:
determine an adjustment factor of a given pixel based on the adjusted maximum brightness value and a peak luminance of a display; and
scale each color component of the given pixel based on the adjustment factor.

16. The computing method of claim 15, wherein the adjustment factor is determined using a tone mapping function selected from the group consisting of: a linear function, a logarithmic function, an exponential function, Reinhard's formula, and a filmic tone mapping operator.

17. The computing method of claim 11, further comprising:
applying an SDR-to-HDR pipeline, including an inverse opto-electric transfer function, an inverse tone mapping algorithm, and an inverse electro-optical transfer function to each pixel in a video frame of the edited SDR video, thereby generating a video frame of an edited HDR video; and
outputting the video frame of the edited HDR video for rendering on a display.

18. The computing method of claim 11, wherein the electro-optical transfer function is Hybrid Log-Gamma (HLG).

19. A computing system for applying effects to a High Dynamic Range (HDR) video, the computing system comprising:
processing circuitry and memory storing instructions that, when executed, cause the processing circuitry to:
receive a video frame of the HDR video, the video frame comprising a plurality of pixels, each pixel having one or a plurality of brightness values for each of a plurality of color components;
apply an HDR-to-SDR pipeline, including an electro-optical transfer function, a tone mapping algorithm, and an opto-electric transfer function to each pixel in the video frame of the HDR video, in this order, thereby generating a video frame of a Standard Dynamic Range (SDR) video with transformed brightness values for each of the plurality of color components;
apply one or more effects to the video frame of the SDR video to thereby generate an edited SDR video;
generate a preview for rendering on a display based on the edited SDR video;
receive a user input to generate an edited HDR video;
responsive to receiving the user input to generate the edited HDR video, apply an SDR-to-HDR pipeline, including an inverse opto-electric transfer function, an inverse tone mapping algorithm, and an inverse electro-optical transfer function to each pixel in a video frame of the edited SDR video, thereby generating a video frame of an edited HDR video; and
output the video frame of the edited HDR video for rendering on the display.

20. The computing system of claim 19, further comprising a camera, wherein
the electro-optical transfer function, the tone mapping algorithm, and the opto-electric transfer function are applied to each pixel in the video frame in real-time as the video frame is received from the camera, such that the video frame of the HDR video is outputted for rendering on the display without perceptible delay.
